(19) United States
(12) Patent Application Publication
(10) Pub. No.: US 2019/0039889 A1
(43) Pub. Date: Feb. 7, 2019

(54) FUEL CARTRIDGE

(71) Applicant: MYFC AB, Stockholm (SE)

(72) Inventors: Michael GLANTZ, Åhus (SE); Björn WESTERHOLM, Saltsjö-Duvnäs (SE); Henrik OLSSON, Solna (SE); Sean MCGEE, Stockholm (SE)

(21) Appl. No.: 16/068,325

(22) PCT Filed: Dec. 20, 2016
(86) PCT No.: PCT/SE2016/051292

§ 371 Date: Jul. 5, 2018

(30) Foreign Application Priority Data
Jan. 5, 2016 (SE) 1650015-9

(51) Int. Cl. C01B 3/08

(52) U.S. Cl. CPC C01B 3/08; H01M 8/04208

(57) ABSTRACT

The invention relates to a novel fuel cartridge for providing hydrogen gas on the basis a reactant system.

Thus, a fuel cartridge for a fuel cell device, comprises a reactor compartment for storing a first reactant, a water compartment for storing water. It has a mixing compartment (106) containing a water soluble second reactant, and a fluid communication means (114) between the mixing compartment (106) and the reactor compartment (102) adapted to pass second reactant dissolved in water to the reactor compartment (102), in which the dissolved second reactant can react with the first reactant to generate a gas. Suitably, the fuel cartridge comprises an interface connectable to a water control mechanism disposed outside the cartridge, the water control mechanism configured to control a flow of the water between the water compartment and the mixing compartment such that the water mixes with and dissolves the second reactant in the mixing compartment.

The present invention relates to fuel cell technology and in particular to a fuel cartridge for providing hydrogen as fuel for fuel cells.

### BACKGROUND

Fuel cells have attracted more interest over the last few years for many applications, both in automotive technology but also in small scale for the production of electricity. One application is for providing charging of electronic equipment, such as mobile phones, laptop computers etcetera.

In the last few years chemical hydride systems have been developed and been in use for a number of products.

In adsorption hydrogen storage for fueling a fuel cell, molecular hydrogen is associated with the chemical fuel by either physisorption or chemisorption. Chemical hydrides, such as lithium hydride (LiH), lithium aluminum hydride (LiAlH4), lithium borohydride (LiBH4), sodium hydride (NaH), sodium borohydride (NaBH4), and the like, are used to store hydrogen gas non-reversibly. Chemical hydrides produce large amounts of hydrogen gas upon reaction with water as shown below:

NaBH₄+2H₂O-»NaBO₂+4H₂

To reliably control the reaction of chemical hydrides with water to release hydrogen gas from a fuel storage device, a catalyst must be employed along with control of the water's pH. Additionally, the chemical hydride is often embodied in a slurry of inert stabilizing liquid to protect the hydride from early release of its hydrogen gas.

In chemical reaction methods for producing hydrogen for a fuel cell, often hydrogen storage and hydrogen release are catalyzed by a modest change in temperature or pressure of the chemical fuel. One example of this chemical system, which is catalyzed by temperature, is hydrogen generation from ammonia-borane by the following reaction:

NH₃BH₃->NH₂BH₂+H₂->NHBH+H₂

The first reaction releases 6.1 wt. % hydrogen and occurs at approximately 120° C., while the second reaction releases another 6.5 wt. % hydrogen and occurs at approximately 160° C. These chemical reaction methods do not use water as an initiator to produce hydrogen gas, do not require a tight control of the system pH, and often do not require a separate catalyst material. However, these chemical reaction methods are plagued with system control issues often due to the common occurrence of thermal runaway. See, for example, U.S. Pat. No. 7,682,411, for a system designed to thermally initialize hydrogen generation from ammonia-borane and to protect from thermal runaway. See, for example, U.S. Pat. Nos. 7,316,788 and 7,578,992, for chemical reaction methods that employ a catalyst and a solvent to change the thermal hydrogen release conditions.

Another more recent reaction system is using NaSi, as disclosed in i.a. in WO 2015/143212.

In a copending application the present inventors disclose a novel reactant system for use in a fuel cartridge for the production of hydrogen for fuel cell applications. The novel system comprises water, a water soluble first reactant and a second solid reactant in the form of aluminium powder. When contacted with an aqueous solution of the first reactant the aluminium will react and produce hydrogen gas.

In connection with the implementation of this reactant system in a fuel cartridge there are certain requirements on a cartridge that should be met.

### SUMMARY OF THE INVENTION

The present inventors have therefore devised a novel fuel cartridge for providing hydrogen gas on the basis a reactant system of the type mentioned above.

This novel fuel cartridge is defined in claim 1.

Thus, a fuel cartridge for a fuel cell device, comprises a reactor compartment for storing a first reactant, a water compartment for storing water. It has a mixing compartment (106) containing a water soluble second reactant, and a fluid communication means (114) between the mixing compartment (106) and the reactor compartment (102) adapted to pass second reactant dissolved in water to the reactor compartment (102), in which the dissolved second reactant can react with the first reactant to generate a gas.

In one embodiment the fuel cartridge comprises an interface connectable to a water control mechanism disposed outside the cartridge, the water control mechanism configured to control a flow of the water between the water compartment and the mixing compartment such that the water mixes with and dissolves the second reactant in the mixing compartment.

In another embodiment the fuel cartridge comprises a water control mechanism within the cartridge.

Furthermore, there is suitably provided means adapted to mix the components of the reactant system with each other.

### BRIEF DESCRIPTION OF THE DRAWINGS

FIG. 1 shows schematically the principle of the fuel cartridge; and

FIG. 2 shows schematically an alternative embodiment.

### DETAILED DESCRIPTION

It is well-known that aluminium dissolves in e.g. aqueous sodium hydroxide with the evolution of hydrogen gas, H₂, and the formation of aluminates of the type [Al(OH)₄]—, and the overall reaction can be written as follows:

2Al(s)+2NaOH(aq)+6H₂O→2Na⁺(aq)+2[Al(OH)₄]⁻+3H₂(g)

The bottom line is that when exposed to aqueous solutions under proper conditions the aluminium dissolves and hydrogen gas evolves.

In the mentioned copending application the present inventors optimized the reaction system by selecting proper forms of aluminium and proper composition of the aqueous solution.

In particular it is important to be able to control the hydrogen evolution, both in terms of rate of evolution but also the spatial distribution, in order to fit the application in which the reactant system is to be used. It has been discovered that if the aluminium is provided as a powder having a specified particle size distribution and surface properties it is possible to obtain a very efficient reactant system.

The pH of the aqueous solution should be in the range pH<14.

The reactant system thus comprises the above mentioned aluminum powder, water and a water soluble compound which results in an alkaline solution, in particular a metal hydroxide such as LiOH, NaOH, KOH, Ca(OH)₂ or Mg(OH)₂ would be usable, NaOH being the preferred one.

The Al powder, the water and the water soluble compound are provided in separate compartments in a fuel cartridge, and the method comprises passing water from one compartment to a mixing compartment wherein the water soluble compound is present whereby the water soluble compound dissolves to provide an aqueous solution. The aqueous solution is passed to the reactor, wherein the Al powder is present, such that a reaction takes place and hydrogen evolves, and passing the hydrogen through an outlet to a fuel cell device.

Preferably the Al powder has a constitution such that it is not reactive when wet, i.e. in contact with pure water. It should not react until brought in contact with the alkaline solution. Most commercially available powders appear to have this property. However, it is preferred that powders for use be tested for this property before implementing in a reactant system as claimed.

Suitably mechanical means are used for feeding the solution through suitable channels. The mechanical means can be pump means, hydraulic/pneumatic systems or the like.

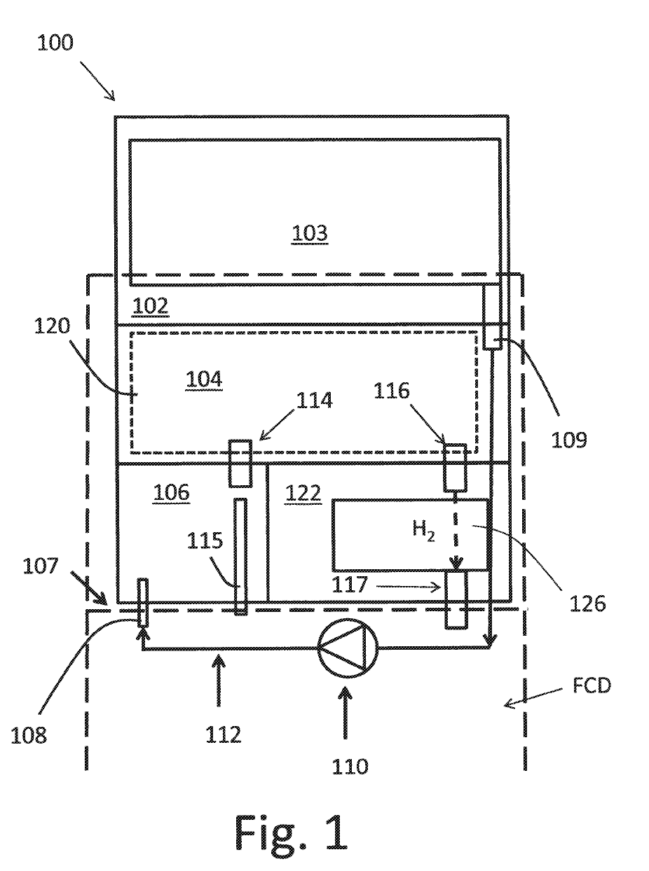

FIG. 1 schematically illustrates the “bottom” part of an embodiment of the novel fuel cartridge 100, i.e. with the “lid” taken away.

It comprises a reactor compartment 104 housing a reactive material (preferably Al powder) and in which an aqueous solution having a pH in the range 12.5 to 14 can be introduced to react with the reactive material (Al powder) to generate hydrogen gas. There is also provided an inlet 114 to said reactor compartment 104 for said aqueous solution, and an outlet 116 for hydrogen gas. The gas H₂ is then passed to a fuel cell device FCD via a connection 117.

As already mentioned above it is important that the aqueous alkaline solution be uniformly distributed in a controlled manner (temporally as well as spatially) in the reactor compartment 104 in order to achieve the most efficient hydrogen production.

The fuel cartridge therefore comprises a porous and hydrophilic member 120 (shown in dashed lines) provided in the reactor compartment 104 at said inlet 114 and having an extension over at least a part of, preferably over the entire inner space of the reactor compartment 104. Suitably the film is provided in contact with the inner wall of the lid part, but in FIG. 1 it is illustrated as located on the bottom of the reactor compartment. It is merely a matter of design considerations that would render one or the other preferable. The porous and hydrophilic member 120 is adapted to convey said aqueous solution by capillary force within the member 120 to distribute the solution over the inside of said reactor chamber. Suitably the porous member 120 is a film of polyethylene (PE). Such films are available from Nitto under the tradename SUNMAP®.

In addition to a reactor compartment 104 the fuel cartridge 100 comprises a water compartment 102, containing a water bag 103, having outlet channel 109, and a mixing compartment 106 having inlet 108.

When the cartridge is to be used it will in one embodiment cooperatively engage with a fuel cell device FCD via an interface 107 (not explicitly shown) that provides a water control mechanism, here illustrated with a pump 110, for transporting water from the water compartment 102 via channel 109, through a channel system 112 in the interface, via inlet 108 to the mixing compartment 106.

In other embodiments the water control mechanism is integrated in the cartridge which thus forms a self-contained unit, described later.

In the mixing compartment 106 the water will dissolve the water soluble compound housed therein, and the solution thus provided is passed through to the reactor compartment 104 via inlet 114.

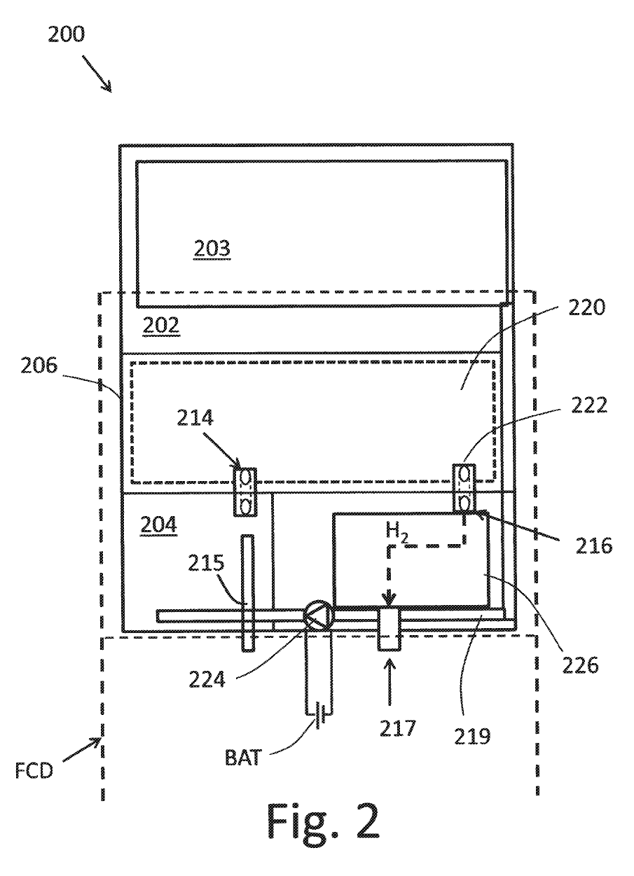

In order that there be no risk for reactant from the mixing compartment to enter the reactor compartment before water has dissolved the reactant, there is provided a valve mechanism in the inlet 114, which is opened when the cartridge is put to use by inserting it in the fuel cell device together with which it is to be used. Preferably this is achieved by a plunger (schematically shown at 115; 215 in FIG. 2) that will penetrate a seal and open up a communication between the compartments.

In the reactor compartment there is provided a porous and hydrophilic member 120, which in the shown embodiment covers practically the entire inner wall of the bottom of the reactor 104. Suitably the member is a film of the material mentioned above. In a preferred embodiment a tab of said film material covers the inlet 114 to act as a filter to prevent unwanted undissolved particles of the water soluble compound to enter the reactor.

In preferred embodiments there is also provided a filter element covering the outlet 116 from the reactor compartment.

It is important that the hydrogen gas be as dry as possible when it is to be used as a fuel in a fuel cell. Since it will always be contaminated with water vapour when it exits the reactor compartment 104, there is provided for drying in a separate drying compartment 122. In this compartment, through which the hydrogen passes before leaving the cartridge through connection 117, there is provided a drying agent, preferably in the form of a fine to mid-sized powder, loosely packed such that the hydrogen can pass without building up a too high pressure. An example of such drying agent is Drierite.

A further aspect of the reactant solution distribution inside the reactor compartment is to ascertain a rapid distribution within the reactive powder. It has been discovered that if small beads of e.g. glass is distributed in the powder a much more efficient spreading occurs, thereby enhancing performance.

These glass beads are preferably spherical and suitably 2.5-2.8 mm in diameter. Suitable beads that have been used in prototypes are obtainable from Preciosa, and are designed and intended for decorative use, e.g. for necklaces.

In FIG. 2 a schematic illustration of a self-contained fuel cartridge 200 is shown. It has essentially the same overall constitution as the embodiment in FIG. 1, but here the water control mechanism, symbolized with a pump 224 provided in the channel system 219, is integrated in the cartridge 200. The pump can be energized by a suitable electrical connection BAT in the device FCD (schematically shown with dashed lines) to which the cartridge is coupled in use.

Preferably the water control mechanism is provided by other means than a pump, e.g. by providing a pressurized water compartment 202, such pressurizing being obtainable by different means such as an overpressure inside the water bag 203 or a mechanical compression means acting on the water bag 203.

All other components remain the same as in the embodiment of FIG. 1, but shown with reference numbers in the 200-series.

1. A fuel cartridge (100) for a fuel cell device, comprising:
a reactor compartment (102) for storing a first reactant;
a water compartment (104) for storing water;
characterized by
a mixing compartment (106) containing a water soluble second reactant;
a fluid communication means (114) between the mixing compartment (106) and the reactor compartment (102) adapted to pass second reactant dissolved in water to the reactor compartment (102), in which the dissolved second reactant can react with the first reactant to generate a gas.

2. The fuel cartridge according to claim 1, comprising an interface (107, 108, 109) connectable to a water control mechanism (110, 112) disposed outside the cartridge (100), the water control mechanism configured to control a flow of the water between the water compartment (104) and the mixing compartment (106) such that the water mixes with and dissolves the second reactant in the mixing compartment (106).

3. The fuel cartridge according to claim 2, wherein the interface comprises a water inlet (108) connectable to a mating outlet of said complementary device, said water inlet (108) of the cartridge (100) is provided with a penetratable seal through which at least a part of said mating outlet can be passed, and wherein said water inlet (108) opens into said mixing chamber (106).

4. The fuel cartridge according to claim 1, comprising a water control mechanism (205, 219, 224, 207) within the cartridge (200).

5. The fuel cartridge according to claim 2, wherein the water control mechanism is configured to cause a flow of water from the water compartment through the mixing compartment to dissolve reactant, and to pass the solution into the reactor compartment.

6. The fuel cartridge according to claim 5, wherein the water control mechanism comprises a pump or a pressurized part of the cartridge or a mechanical compression means.

7. The fuel cartridge according to claim 1, wherein said water compartment (102) houses a flexible bag (103) containing water, said bag being penetratable by a piercing element.

8. The fuel cartridge according to claim 7, wherein said piercing element is hollow and adapted to pass water from the flexible bag (103) to the water control mechanism.

9. The fuel cartridge according to claim 1, further comprising a valve mechanism in the inlet (114) to the reactor compartment configured to open when the cartridge is put into use.

10. The fuel cartridge according to claim 9, wherein the valve mechanism comprises a plunger (115, 215) actuatable upon insertion of the cartridge (100; 200) into a fuel cell device (FCD).

11. The fuel cartridge according to claim 3, wherein the water control mechanism is configured to cause a flow of water from the water compartment through the mixing compartment to dissolve reactant, and to pass the solution into the reactor compartment.

12. The fuel cartridge according to claim 11, wherein the water control mechanism comprises a pump or a pressurized part of the cartridge or a mechanical compression means.

13. The fuel cartridge according to claim 4, wherein the water control mechanism is configured to cause a flow of water from the water compartment through the mixing compartment to dissolve reactant, and to pass the solution into the reactor compartment.

14. The fuel cartridge according to claim 13, wherein the water control mechanism comprises a pump or a pressurized part of the cartridge or a mechanical compression means.
